(19) United States
(12) Patent Application Publication
(10) Pub. No.: US 2016/0227024 A1
(43) Pub. Date: Aug. 4, 2016

(54) SYSTEM AND METHOD FOR PROCESSING VOICE CALLS FROM MULTIPLE VOICE CALLING APPLICATIONS

(71) Applicant: RingCentral, Inc., Belmont, CA (US)

(72) Inventors: Vlad Vendrow, Redwood Shores, CA (US); Alexander Alekseevich Pantyukhin, St. Petersburg (RU)

(21) Appl. No.: 14/941,486

(22) Filed: Nov. 13, 2015

Related U.S. Application Data
(63) Continuation of application No. PCT/RU2015/000053, filed on Jan. 30, 2015.

(51) Int. Cl. H04M 1/725; H04W 4/00

(52) U.S. Cl. CPC H04M 1/72597; H04M 1/72522; H04W 4/003

(57) ABSTRACT

Methods, systems, and apparatus, including computer programs encoded on a computer storage medium, for processing voice calls received by a mobile device. One of the methods includes receiving, by a mobile device configured with a plurality of voice calling applications, a first incoming voice call through a first voice calling application of the plurality of voice calling applications; determining that, when the first incoming voice call is received, a second voice call is ongoing through a second, different voice calling application of the plurality of voice calling applications; selecting a processing rule that applies to the first voice calling application and the second voice calling application from a set of one or more processing rules; and processing the first incoming voice call in accordance with the selected processing rule.

### CROSS-REFERENCE TO RELATED APPLICATION

This application is a continuation of and claims priority to PCT Application No. PCT/RU2015/000053, filed on Jan. 30, 2015, the disclosure of which is hereby incorporated by reference in its entirety.

### BACKGROUND

This disclosure relates to processing voice calls received at a mobile device.

Many mobile devices, e.g., smart phones, tablets, or other portable user computers, are configured with multiple software applications through which users of the mobile devices can participate in voice calls with users of other communication devices. For example, a mobile device may be configured with a default voice calling application that communicates with a cellular telephony service provider to allow the user to place and receive voice calls over a cellular network. The mobile device may also be configured with one or more other voice calling applications that allow the user to place and receive voice calls using Voice Over Internet Protocol (VOIP). Other mobile devices, e.g., tablets or smart phones operating without cellular connectivity, may not be able to communicate over a cellular network but may be configured with multiple VOIP voice calling applications.

When a mobile device is configured with multiple voice calling applications, the mobile device may receive an incoming voice call through one of the applications while another voice call is ongoing through another one of the applications.

### SUMMARY

In general, one innovative aspect of the subject matter described in this disclosure can be embodied in methods that include the actions of receiving, by a mobile device configured with a plurality of voice calling applications, a first incoming voice call through a first voice calling application of the plurality of voice calling applications; determining that, when the first incoming voice call is received, a second voice call is ongoing through a second, different voice calling application of the plurality of voice calling applications; selecting a processing rule that applies to the first voice calling application and the second voice calling application from a set of one or more processing rules; and processing the first incoming voice call in accordance with the selected processing rule.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination thereof, installed on the system that in operation causes or cause the system to perform the actions. One or more computer programs can be configured to perform particular operations or actions by virtue of including instructions that, when executed by data processing apparatus of the present disclosure, cause the apparatus to perform the actions.

These and other embodiments can optionally include one or more of the following features. The actions can further include: classifying the second voice calling application as a voice calling application based on a type of the second voice calling application. Determining that the second voice call is ongoing through the second voice calling application can include: determining that the second voice calling application has been classified as a voice calling application.

Determining that the second voice call is ongoing through the second voice calling application can include: determining that the second voice calling application has activity that is indicative of an ongoing voice call. Determining that the second voice calling application has activity that is indicative of an ongoing voice call can include: determining that the second voice calling application is receiving audio signals from a user of the mobile device; and determining that the second voice calling application is transmitting data over a network.

The selected processing rule can specify one or more call-related actions to be performed when incoming calls are received while another call is ongoing through a different voice calling application. Processing the first incoming voice call in accordance with the selected processing rule can include causing the first voice calling application to perform the one or more call-related actions.

The selected processing rule can be a priority-based rule that defines a relative priority between the first voice calling application and the second voice calling application and that specifies one or more higher priority call-related actions and one or more lower priority call-related actions. Processing the first incoming voice call in accordance with the selected processing rule can include: determining whether the first voice calling application has a higher or lower priority than the second voice calling application; when the first voice calling application has a higher priority than the second voice calling application, causing the second voice calling application to perform the one or more higher priority call-related actions; and when the first voice calling application has a lower priority than the second voice calling application, causing the first voice calling application to perform the one or more lower priority call-related actions. The higher priority call-related actions can include terminating or placing on hold the second voice call ongoing through the second voice calling application, and the lower priority call-related actions can include rejecting or sending to voice mail the first incoming voice call received through the first voice calling application.

The actions can further include identifying a caller placing the first incoming voice call; determining that the caller is not associated with any call-related actions by any caller-specific rules; and in response to the determining, processing the call using the selected processing rule.

The details of one or more embodiments of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example mobile device that is configured with multiple voice calling applications.

FIG. 2 is a flow diagram of an example process for processing an incoming voice call.

FIG. 3 is a flow diagram of an example process for processing an incoming voice call using a priority-based processing rule.

FIG. 4 is a flow diagram of an example process for processing an incoming voice call using a caller-specific rule.

Like reference numbers and designations in the various drawings indicate like elements.

### DETAILED DESCRIPTION

The present disclosure generally describes how a mobile device that is configured with multiple voice calling applications processes incoming voice calls that are received while another voice call is ongoing on the mobile device. In particular, the mobile device receives an incoming voice call through one voice calling application of the multiple voice calling applications that are configured on the mobile device. The mobile device determines that another voice call is ongoing through a different voice calling application and selects a processing rule that applies to the voice calling application through which the incoming call is received and the other voice calling application through which the other call is ongoing. The mobile device then processes the incoming voice call in accordance with the selected processing rule.

Particular embodiments of the subject matter described in this disclosure can be implemented so as to realize one or more of the following advantages. A mobile device that is configured with multiple voice calling applications can effectively process incoming calls received while another call is already ongoing through a different voice calling application, improving the user experience of the user device. In particular, all incoming voice calls received through any of the voice calling applications configured on the mobile device are monitored by one process, ensuring that incoming voice calls do not undesirably interrupt or interfere with voice calls that are ongoing through other voice calling applications. Additionally, a user can specify a priority between the voice calling applications, so that less important voice calls do not interrupt or otherwise undesirably interfere with more important calls through different applications that are already ongoing. Furthermore, a user can specify caller-specific rules, ensuring that calls from a caller or a group of callers identified in a caller-specific rule are processed according to the user's preferences, regardless of which voice calling application the call is received through.

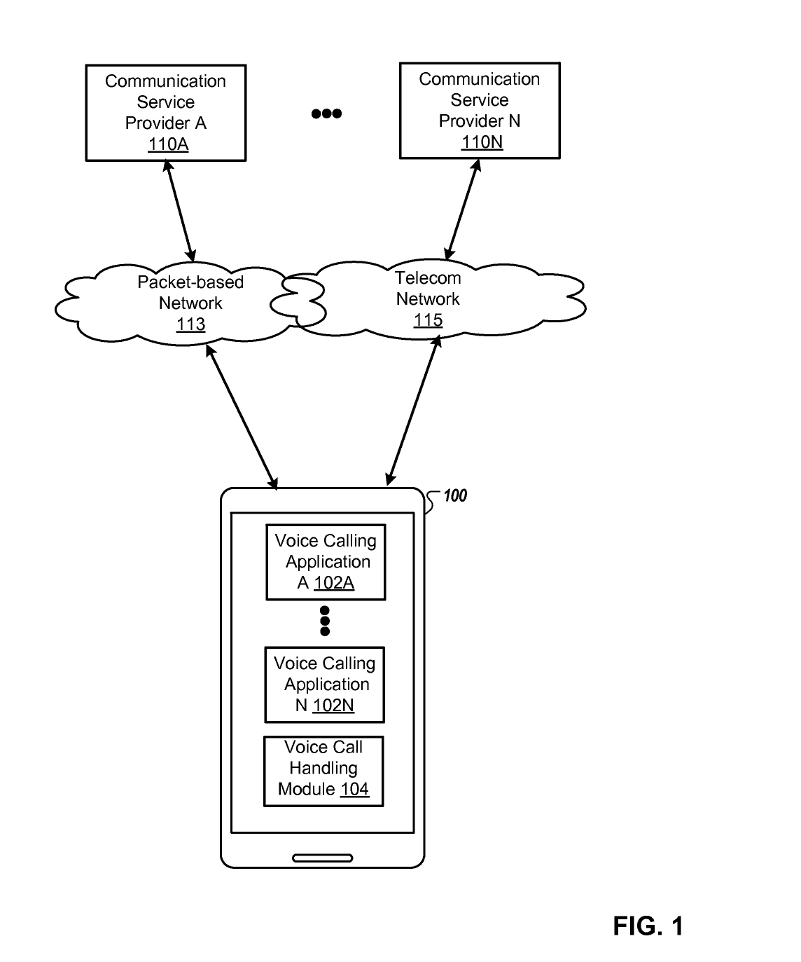

FIG. 1 shows an example mobile device 100 that is configured with multiple voice calling applications 102A-102N. The mobile device 100 can be configured with an application and, similarly, an application can be configured on the mobile device 100 by virtue of the application being installed on the mobile device. In some cases, the mobile device 100 can also be considered as being configured with a web-based application when the web-based application is being accessed by the user over a network, e.g., through a web browser or other special purpose application installed on the mobile device 100.

A user of the mobile device 100 can participate in voice calls through each of the voice calling applications 102A-102N by communicating with a service provider, e.g., one of multiple communication service providers 110A-110N, or directly with a remote communications device of another user over a packet-based network 113, a telecommunications (“telecom”) network 115, or both. Generally, a voice call is an interaction between a user of the mobile device 100 and another participant in the voice call that includes audio signals generated by the user being captured by the mobile device 100 and transmitted from the mobile device 100 to the other participant over a network, e.g., over the packet-based network 113, the telecom network 115, or both.

The packet-based network 113 carries data in packetized form over a packet-switched network (e.g., the Internet) and can include local area networks (LAN), wide area networks (WAN), wireless LANs, WiMax networks, etc. The telecom network 115 carries voice communications and includes public switched telephone networks (PSTN), cellular networks, Voice over IP (VoIP) networks, etc. As indicated in FIG. 1, there is some overlap between the telecom network 115 and the packet network 113 since VoIP communications are also packetized and carried over the Internet.

For example, if the mobile device 100 includes a radio link to communicate with a cellular telephony service provider over the telecom network 115, one of the voice calling applications 102A-N is a default voice calling application for making cellular calls over a cellular network, i.e., the telecom network 115. The default voice calling application may be, for example, included as: a component of an operating system configured on the mobile device 100, a part of the firmware of the mobile device 100, a stand-alone process provided by the cellular service provider, and so on. Alternatively, the default voice calling application can be an application that has been selected from among the applications 102A-N as the default voice calling application by a user of the mobile device 100.

As another example, one or more of the multiple voice calling applications 102A-100N may be a VOIP application that allows the user to place VOIP calls over the packet-based network 113, the telecom network 115, or both.

As another example, one or more of the multiple voice calling applications 102A-100N may be a video conferencing application that allows the user to participate in video conferences over the packet-based network 113.

As another example, one or more of the multiple voice calling applications 102A-100N may be a social networking application that allows the user to participate in VOIP video calls with social network contacts of the user over the packet-based network 113, the telecom network 115, or both.

The mobile device 100 is also configured with a voice call handling module 104. While the voice call handling module 104 is shown as a separate process in FIG. 1, in some embodiments the voice call handling module 104 is a component of another process configured on the mobile device 100, e.g., one of the voice calling applications 102A-N or of the operating system of the mobile device 100.

When an incoming voice call is received through one of the voice calling applications 102A-N, the voice call handling module 104 determines whether another voice call is ongoing through a different one of the voice calling applications 102-N.

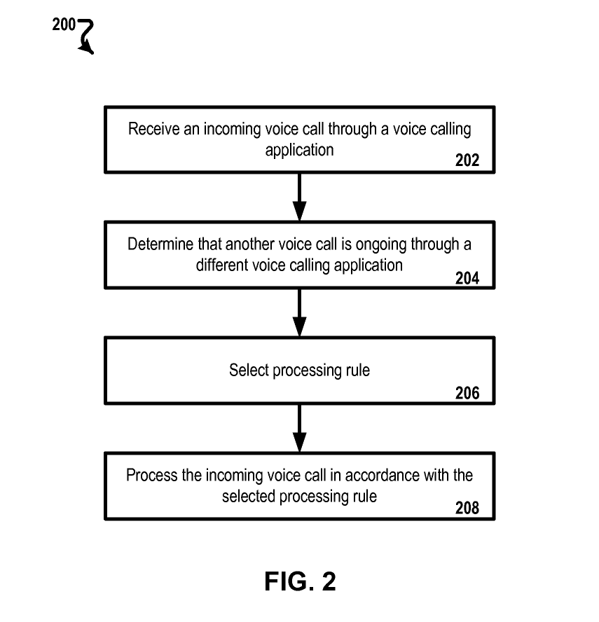

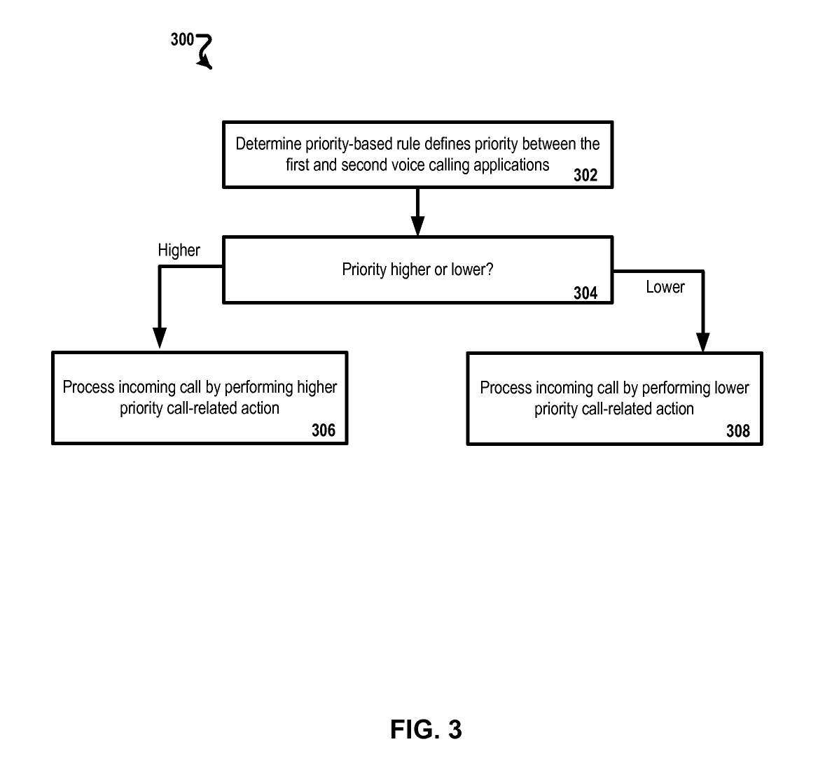

If another voice call is ongoing through a different application, the voice call handling module 104 determines how to process the incoming voice call based on a set of one or more processing rules maintained by the voice call handling module 104. Each of the processing rules defines, for one subset of the voice calling applications 102A-N, how incoming voice calls received through the voice calling application are processed by the mobile device 100 when received when another voice call is already ongoing through a different application from another subset of the voice calling applications 102A-N. Processing an incoming call using a processing rule is described below with reference to FIGS. 2 and 3.

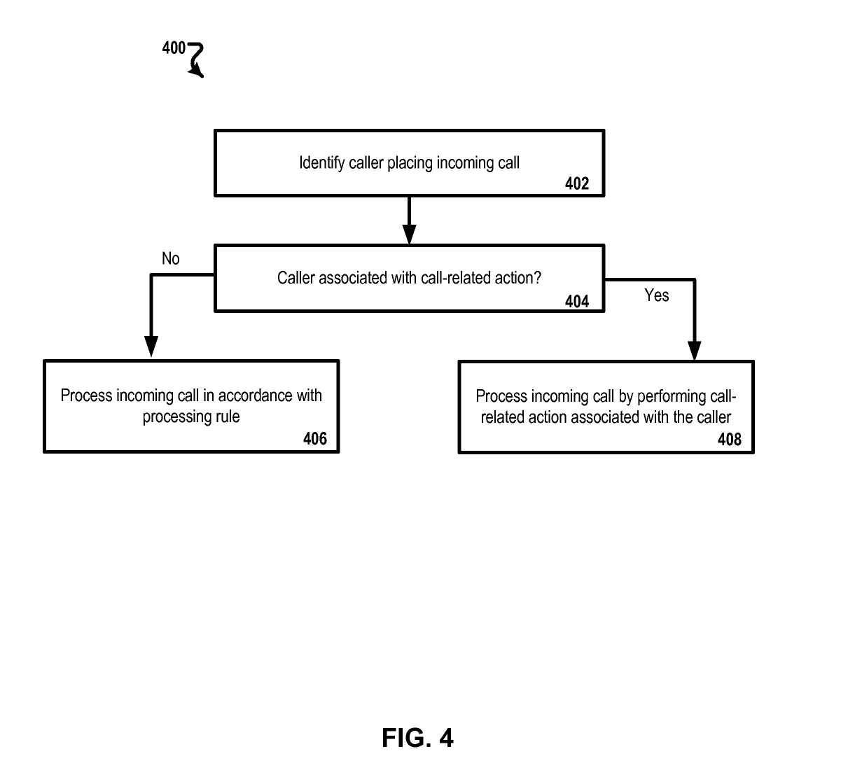

Optionally, the voice call handling module 104 also maintains one or more caller-specific rules. Each caller-specific rule associates a respective caller or caller group with a specific call-related action. Processing an incoming call using a caller-specific rule is described below with reference to FIG. 4.

FIG. 2 is a flow diagram of an example process 200 for processing an incoming voice call. The process 200 can be performed by a mobile device that is configured with multiple voice calling applications. For example, the mobile device 100 of FIG. 1 can perform the process 200.

At step 202, an incoming voice call is received by a mobile device through a first voice calling application. The first voice calling application is one of multiple voice calling applications that are configured on the mobile device. For example, the first voice calling application may be a default voice calling application that receives and places cellular voice calls over a cellular network. As another example, the first voice calling application may be a VOIP application that places VOIP calls over the cellular network or over a packet-based network, e.g., the Internet.

In some embodiments, the determination is made that an incoming voice call has been received through a first voice calling application in response to receiving a notification that the call is being received, e.g., by monitoring notifications generated by the first voice calling application or by receiving a notification or other data from the operating system of the mobile device indicating that the voice call has been received through the first voice calling application. In some other embodiments, it is determined that an incoming voice call has been received when an application executing on the mobile device has activity that satisfies certain criteria. In one example, the activity of the application satisfies the criteria when an application previously classified as a voice calling application receives a signal over a network, e.g., over the cellular network or the packet-based network. Classifying applications as voice calling applications is described below. In another example, the activity of the application satisfies the criteria when the application requests to use the speaker and microphone of the mobile device in response to a signal received by the application over the network.

At step 204, a determination is made that another voice call is ongoing through a second voice calling application configured on the mobile device. The determination may be made in any of a variety of ways.

In some embodiments, when a new application is installed on the mobile device, a determination is made as to whether or not to classify the application as a voice calling application. For example, in some embodiments, as part of the installation process, the new application can provide registration information to the operating system of the mobile device that identifies a type of the application. The type of the application identified in the registration information can then be used to determine whether or not to classify the application as a voice calling application, e.g., by classifying applications that have specified types as voice calling applications, e.g., videoconferencing applications, VOIP applications, cellular applications, and so on. If registration information that identifies the type of a newly installed application is unavailable, a request may be submitted to the newly installed application to determine the type of the application.

In some other embodiments, data can be maintained that identifies known voice calling applications. In these embodiments, identifiers of newly installed applications can be compared to the maintained data to determine whether the newly installed application is identified in the maintained data and, if so, the newly installed application can be classified as a known voice calling application. Updates to the maintained data can be pushed to the mobile device over the network, e.g., in response to updates to a list of known voice calling applications by a system administrator.

Once a given application is classified as a voice calling application, in some embodiments, it is determined that a voice call is ongoing through the application if the application is executing and is the active application when the incoming call is received.

In some embodiments, e.g., if data identifying which applications installed on the mobile device are voice calling applications is unavailable or if for certain applications a determination is not able to be made, applications currently executing on the mobile device can be identified. If one of the executing applications has activity that is indicative of an ongoing voice call, it is determined that a voice call is ongoing through the application. In particular, if an executing application is using the microphone of the mobile device or is otherwise receiving audio signals from a user of the mobile device and is transmitting data over a network, it is determined that a voice call is ongoing through the application. Optionally, other activity may also be required to be detected. For example, the amount of data being transmitted over the network or received by the application over the network must exceed a threshold amount. As another example, the application must also be using a speaker of the mobile device to provide audio to the user of the mobile device.

In some embodiments, even if an application that has previously been classified as a voice calling application is executing and active, the voice calling application must still satisfy one or more of the above activity criteria before it is determined that a voice call is ongoing through the voice calling application. For example, an application classified as a voice calling application may be required to be executing, transmitting, or both more than a threshold amount of data over the network in order for it to be determined that a voice call is ongoing through the application.

At step 206, a processing rule that applies to the first voice calling application and the second voice calling application is selected. The processing rule may be selected from a set of one or more processing rules. Each of the one or more processing rules define, for some or all of the voice applications configured on the mobile device, how incoming calls received through one of the voice calling applications configured on the mobile device are processed when received while another voice call is ongoing through another one of the voice calling applications configured on the mobile device.

For example, the set of one or more processing rules may include a default processing rule that specifies that, for all of the voice calling applications configured on the mobile device, one or more particular call-related actions are to be taken with respect to all incoming calls received through one voice calling application while another call is ongoing through a different application. In some example embodiments, the default processing rule specifies that the incoming call should be rejected and sent to voice mail. In some other example embodiments, the default processing rule specifies that the incoming call should be rejected and sent to voice mail and a message transmitted to the caller placing the incoming call that specifies that the user of the mobile device is not available to take the incoming call, e.g., a message that indicates that the user is on another call or that the user is busy.

As another example, the set of one or more processing rules may include one or more priority-based rules. Each priority-based rule defines a relative priority between two or more of the voice calling applications. Each priority-based rule also defines one or more higher priority call-related actions and one or more lower priority call processing actions. A higher priority call-related action is an action to be taken when the incoming call is through a voice calling application that has a higher priority than the voice calling application through which the other call is ongoing. A lower priority call-related action is an action to be taken when the incoming call is through a voice calling application that has a lower priority than the voice calling application through which the other call is ongoing.

Processing an incoming call is described in more detail below with reference to FIG. 3.

In some embodiments, some or all of the processing rules are specified by a user of the mobile device. For example, a user interface can be presented on the mobile device to the user that allows the user to specify a priority between two or more of the applications configured on the mobile device and the higher priority and lower priority call-related actions. As another example, the user interface can allow the user to modify the call-related actions specified by the default processing rule.

At step 208, the incoming voice call is processed in accordance with the selected processing rule. That is, instructions are sent to the first application that cause the first application to perform the call-related actions specified by the selected processing rule, e.g., to reject the incoming call and send a message to the caller or to accept the incoming call and switch the first voice calling application to being the active application on the mobile device.

FIG. 3 is a flow diagram of an example process 300 for processing an incoming voice call in accordance with a priority-based rule. The process 300 can be performed by a mobile device that is configured with multiple voice calling applications. For example, the mobile device 100 of FIG. 1 can perform the process 300.

At step 302, a determination is made that a priority-based rule that defines a priority between the first voice calling application through which the incoming call is being received and the second voice calling application through which the ongoing call is ongoing is included in the set of one or more processing rules maintained on the mobile device.

At step 304, a determination is made whether the first voice calling application has a higher or lower priority than the second voice calling application.

At step 306, if the first voice calling application has a higher priority than the second voice calling application, the incoming call is processed by causing the first application, the second application, or both applications to perform the higher priority call-related actions that are specified in the priority-based rule. For example, the higher priority call-related actions may be to accept the incoming call and to terminate or place on hold the ongoing call. In this example, instructions are sent to cause the second application to terminate or place on hold the ongoing call and instructions are sent to the first application to accept the incoming call and to make the first application active on the mobile device. As another example, the call-related actions may also include sending a message to the other participant in the ongoing call indicating that another call has been received by the mobile device.

At step 308, if the first voice calling application has a lower priority than the second voice calling application, the incoming call is processed by causing the first application to perform the lower priority call-related actions that are specified in the priority-based rule. For example, the lower priority call-related actions may be to reject and send to voice mail the incoming call. As another example, the lower priority call-related actions may also include sending a message to the caller placing the incoming call that specifies that the user of the mobile device is not available to take the incoming call.

FIG. 4 is a flow diagram of an example process 400 for processing an incoming voice call in accordance with a caller-specific rule. The process 400 can be performed by a mobile device that is configured with multiple voice calling applications. For example, the mobile device 100 of FIG. 1 can perform the process 400.

At step 402, a caller placing the incoming the call is identified. For example, the caller can be identified by submitting a request to the first voice calling application for an identifier of the caller.

At step 404, a determination is made as to whether or not the caller is associated with one or more call-related actions by a caller-specific processing rule in the set of one or more processing rules maintained by the mobile device. The caller-specific processing rule can either associate the caller with one or more call-related actions or associate a caller group that includes the caller with the one or more call-related actions. A given caller-specific processing rule can be, for example, defined in the contact list of the mobile device, obtained from a global registry, or retrieved from a database on a telephony server.

At step 406, if the caller is not associated with a call-related action, the incoming call is processing according to a processing rule, i.e., a processing rule that applies to the first and second voice calling applications.

At step 408, if the caller is associated with one or more call-related actions, the incoming call is processed by performing the call-related action that is associated with the caller. That is, the first application, the second application, or both are caused to perform the call-related actions associated with the caller. For example, for an important caller, the call-related action may be to accept the incoming call and terminate or place on hold the ongoing call. As another example, for an unimportant caller, the call-related action may be to reject the incoming call even if the first application has a higher priority than the second application.

Embodiments of the subject matter and the operations described in this disclosure can be implemented in digital electronic circuitry, or in computer software, firmware, or hardware, including the structures disclosed in this disclosure and their structural equivalents, or in combinations of one or more of them. Embodiments of the subject matter described in this disclosure can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media.

The operations described in this disclosure can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing configured for implementing the teachings of the present disclosure. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. However, a computer need not have such devices. Moreover, a computer can be embedded in another device, e.g., a mobile telephone, a smart phone, a mobile audio or video player, a game console, a Global Positioning System (GPS) receiver, and a wearable computer device, to name just a few. Devices suitable for storing computer program instructions and data include all forms of non-volatile memory, media and memory devices, including by way of example semiconductor memory devices, magnetic disks, and the like. The processor and the memory can be supplemented by, or incorporated in, special purpose logic circuitry.

To provide for interaction with a user, embodiments of the subject matter described in this disclosure can be implemented on a computer having a display device for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input and output.

While this disclosure contains many specific implementation details, these should not be construed as limitations on the scope of the present disclosure or of what may be claimed, but rather as descriptions of features specific to particular embodiments of the present disclosure. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by a mobile device configured with a plurality of voice calling applications, a first incoming voice call through a first voice calling application of the plurality of voice calling applications;
determining that, when the first incoming voice call is received, a second voice call is ongoing through a second, different voice calling application of the plurality of voice calling applications;
selecting a processing rule that applies to the first voice calling application and the second voice calling application from a set of one or more processing rules; and
processing the first incoming voice call in accordance with the selected processing rule.

2. The method of claim 1, further comprising:
classifying the second voice calling application as a voice calling application based on a type of the second voice calling application, wherein determining that the second voice call is ongoing through the second voice calling application comprises:
determining that the second voice calling application has been classified as a voice calling application.

3. The method of claim 1, wherein determining that the second voice call is ongoing through the second voice calling application comprises:
determining that the second voice calling application has activity that is indicative of an ongoing voice call.

4. The method of claim 3, wherein determining that the second voice calling application has activity that is indicative of an ongoing voice call comprises:
determining that the second voice calling application is receiving audio signals from a user of the mobile device; and
determining that the second voice calling application is transmitting data over a network.

5. The method of claim 1, wherein the selected processing rule specifies one or more call-related actions to be performed when incoming calls are received while another call is ongoing through a different voice calling application.

6. The method of claim 5, wherein processing the first incoming voice call in accordance with the selected processing rule comprises causing the first voice calling application to perform the one or more call-related actions.

7. The method of claim 1, wherein the selected processing rule is a priority-based rule that defines a relative priority between the first voice calling application and the second voice calling application and that specifies one or more higher priority call-related actions and one or more lower priority call-related actions.

8. The method of claim 7, wherein processing the first incoming voice call in accordance with the selected processing rule comprises:
determining whether the first voice calling application has a higher or lower priority than the second voice calling application;
when the first voice calling application has a higher priority than the second voice calling application, causing the second voice calling application to perform the one or more higher priority call-related actions; and
when the first voice calling application has a lower priority than the second voice calling application, causing the first voice calling application to perform the one or more lower priority call-related actions.

9. The method of claim 8, wherein the higher priority call-related actions comprise terminating or placing on hold the second voice call ongoing through the second voice calling application, and wherein the lower priority call-related actions comprise rejecting or sending to voice mail the first incoming voice call received through the first voice calling application.

10. The method of claim 1, further comprising:
identifying a caller placing the first incoming voice call;
determining that the caller is not associated with any call-related actions by any caller-specific rules; and
in response to the determining, processing the call using the selected processing rule.

11. A computer storage medium encoded with a computer program, the computer program comprising instructions that when executed by a mobile device configured with a plurality of voice calling applications cause the mobile device to perform operations comprising:
receiving a first incoming voice call through a first voice calling application of the plurality of voice calling applications;
determining that, when the first incoming voice call is received, a second voice call is ongoing through a second, different voice calling application of the plurality of voice calling applications;
selecting a processing rule that applies to the first voice calling application and the second voice calling application from a set of one or more processing rules; and
processing the first incoming voice call in accordance with the selected processing rule.

12. The computer storage medium of claim 11, wherein the selected processing rule specifies one or more call-related actions to be performed when incoming calls are received while another call is ongoing through a different voice calling application.

13. The computer storage medium of claim 12, wherein processing the first incoming voice call in accordance with the selected processing rule comprises causing the first voice calling application to perform the one or more call-related actions.

14. The computer storage medium of claim 11, wherein the selected processing rule is a priority-based rule that defines a relative priority between the first voice calling application and the second voice calling application and that specifies one or more higher priority call-related actions and one or more lower priority call-related actions.

15. The computer storage medium of claim 14, wherein processing the first incoming voice call in accordance with the selected processing rule comprises:
determining whether the first voice calling application has a higher or lower priority than the second voice calling application;
when the first voice calling application has a higher priority than the second voice calling application, causing the second voice calling application to perform the one or more higher priority call-related actions; and
when the first voice calling application has a lower priority than the second voice calling application, causing the first voice calling application to perform the one or more lower priority call-related actions.

16. The computer storage medium of claim 15, wherein the higher priority call-related actions comprise terminating or placing on hold the second voice call ongoing through the second voice calling application, and wherein the lower priority call-related actions comprise rejecting or sending to voice mail the first incoming voice call received through the first voice calling application.

17. A mobile device configured with a plurality of voice calling applications, wherein the mobile device is configured to perform operations comprising:
receiving a first incoming voice call through a first voice calling application of the plurality of voice calling applications;
determining that, when the first incoming voice call is received, a second voice call is ongoing through a second, different voice calling application of the plurality of voice calling applications;
selecting a processing rule that applies to the first voice calling application and the second voice calling application from a set of one or more processing rules; and
processing the first incoming voice call in accordance with the selected processing rule.

18. The mobile device of claim 17, wherein the selected processing rule specifies one or more call-related actions to be performed when incoming calls are received while another call is ongoing through a different voice calling application.

19. The mobile device of claim 17, wherein the selected processing rule is a priority-based rule that defines a relative priority between the first voice calling application and the second voice calling application and that specifies one or more higher priority call-related actions and one or more lower priority call-related actions.

20. The mobile device of claim 19, wherein processing the first incoming voice call in accordance with the selected processing rule comprises:
determining whether the first voice calling application has a higher or lower priority than the second voice calling application;
when the first voice calling application has a higher priority than the second voice calling application, causing the second voice calling application to perform the one or more higher priority call-related actions; and
when the first voice calling application has a lower priority than the second voice calling application, causing the first voice calling application to perform the one or more lower priority call-related actions.
